(19) United States
(12) Patent Application Publication
(10) Pub. No.: US 2024/0157663 A1
(43) Pub. Date: May 16, 2024

(54) FORMING A CONTOURED FINISHED SOFT GOOD FROM A FLATTER FIBROUS INTERMEDIATE PART

(71) Applicant: Simplifyber, Inc., Raleigh, NC (US)

(72) Inventors: Maria Intscher-Owrang, Brooklyn, NY (US); Philip Cohen, Nashville, TN (US); Joseph Miller, Raleigh, NC (US); Juliana Marangon Jardim, Raleigh, NC (US)

(21) Appl. No.: 18/511,352

(22) Filed: Nov. 16, 2023

Related U.S. Application Data
(60) Provisional application No. 63/425,768, filed on Nov. 16, 2022.

(51) Int. Cl. B29D 35/12; A43B 23/04

(52) U.S. Cl. CPC B29D 35/126; A43B 23/042

(57) ABSTRACT

The present invention is a method for forming a fibrous molded article that includes providing a aqueous slurry containing a plurality of fibers, providing the slurry into a dehydration chamber to remove at least some of the amount of water from the slurry to achieve an intermediate form, removing the fibrous intermediate form from the dehydration chamber and placing the fibrous intermediate form in a press having a first mold portion and a second mold portion wherein at least one of the first or second mold portions includes a contour, applying at least one of heat and pressure to the press such that at least fiber to fiber bonding or chemical cross-linking of fibers occurs, and removing the three-dimensional solid fibrous molded part from the press.

### PRIORITY CLAIM

This application claims the benefit of U.S. Provisional Patent Application Ser. No. 63/425,768 filed on Nov. 16, 2022, which is incorporated by reference herein in its entirety.

### FIELD OF THE INVENTION

The field of the invention is apparatus and method for molding a three-dimensional article and, more specifically, for molding a solid fibrous three-dimensional article from an aqueous slurry that contains a plurality of fibers to an intermediate part that is substantially flat or slightly contoured and then, in a post-forming operation, altering the shape of the molded fibrous intermediate part to a second shape.

### BACKGROUND OF THE INVENTION

The current process for creating soft goods, such as clothing, footwear (e.g., shoe uppers), bags, furniture, medical supplies, cleaning tools and consumables, toys, automotive interior parts, cases and housings for consumer electronics, and other soft goods is often wasteful and includes numerous steps. Within each manufacturing step is a separate, inefficient, labor-intensive process that often requires transport of materials between the steps. Scrap materials (e.g., cloth that is cut but not used) are often simply discarded, adding to the waste in the process. Additionally, it has been creating molds for highly contoured items are often expensive and require complex equipment that requires, e.g., numerous moving parts. It has also been found that certain soft goods, especially those that are highly contoured are assembled from numerous parts. It has also been found that highly contoured soft goods frequently do not stack well and are expensive to ship. These and other shortcomings in the prior art are addressed by the present invention, as disclosed herein.

### SUMMARY OF THE INVENTION

According to one aspect of the present invention a method for forming a fibrous molded article includes: providing a aqueous slurry containing a plurality of fibers, providing the slurry into a dehydration chamber to remove at least some of the amount of water from the slurry to achieve an intermediate form, removing the fibrous intermediate form from the dehydration chamber and placing the fibrous intermediate form in a press having a first mold portion and a second mold portion wherein at least one of the first or second mold portions includes a contour, applying at least one of heat and pressure to the press such that at least fiber to fiber bonding or chemical cross-linking of fibers occurs, and removing the three-dimensional solid fibrous molded part from the press.

According to another aspect of the present invention, the slurry is in the form of a mixture, foam, or homogeneous suspension after mixing.

According to a further aspect of the invention, the slurry includes at least one type of fiber selected from natural fibers, semi-synthetic fibers, and synthetic fibers.

According to an even further aspect of the invention, the slurry includes at least one type of fiber selected from natural fibers, semi-synthetic fibers, and synthetic fibers.

According to an even further aspect of the invention, the slurry includes more than one type of fibers selected from natural fibers, synthetic fibers, semi-synthetic fibers, and synthetic fibers.

According to an even further aspect of the invention, the slurry includes biobased molecules or polymers, including for example, chitosan, starches, ionic starches, cellulosic materials such as, but not limited to, carboxymethylcellulose, nanofibrillated cellulose, nanocellulose; natural rubber latex, collagen, gelatine, alginate, polylactic acid, polyglycolic acid, and/or polyhydroxyalkanoates.

According to a an even further aspect of the invention, at least one of the first mold portion and the second mold portion includes at least one of a contour, a texture, a pattern that is imparted onto the three-dimensional solid fibrous molded part.

One advantage of the present invention includes the reduction in the cost of molds by making them flatter and requiring less material.

Another advantage of the present invention includes the reduction in complexity of mold set, by reducing the need for splitable or flexible elements, or reducing the number of pieces in the mold.

A further advantage of the present invention includes a greater ability to stack partially made items together so that they may be transported or stored before use.

These and other advantages will be apparent to one of skill in the art in light of the present disclosure and drawings.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a diagrammatic set up for adding at least some of the desired ingredients of the slurry into a mixer;

FIG. 2A shows one embodiment of a generally rectangular dehydration chamber intended to produce a substantially flat dehydrated fibrous sheet;

FIG. 2B shows another embodiment of a generally rectangular dehydration chamber intended to produce a dehydrated fibrous sheet with a contour;

FIG. 3 shows an image of a dehydrated flat sheet;

FIG. 4 shows a diagrammatic exploded view of one embodiment of a pressing chamber intended to press a dehydrated flat sheet into a butterflied shoe upper;

FIG. 5 shows a diagrammatic view of the steps of removing the butterflied shoe upper from the pressing chamber and performing secondary operations;

FIG. 6 is a photographic image of one example of an intermediate form for a shoe upper; and

FIG. 7 is a photographic image of one example of an intermediate form converted into a final shape and affixed to additional components to form a completed shoe.

### DETAILED DESCRIPTION OF THE INVENTION

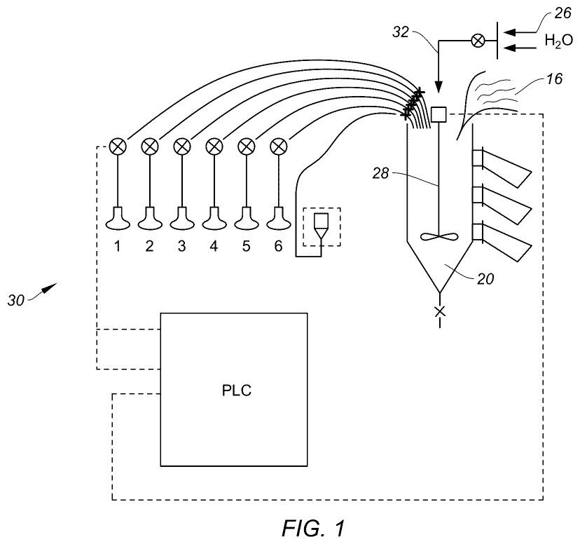

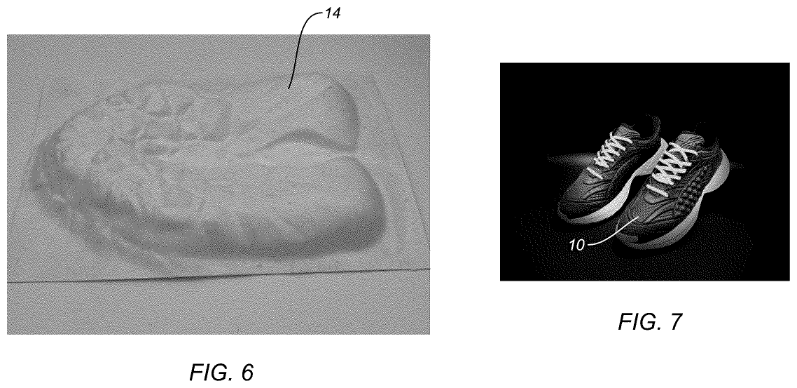

Referring now to FIGS. 1-7, the present invention is an article 10 that is a three-dimensional solid fibrous molded part 12 that includes at least one contour, as well as a method for making the article. The three-dimensional solid fibrous molded part 12 is first formed into an intermediate form 14 and then, in a secondary operation, converted into a final shape and, optionally, attached or otherwise affixed to additional components. Common articles formed using the methods and apparatus disclosed herein include, but are not limited to, footwear, clothing and various other apparel, bags and various other accessories, automotive interior upholstery and parts, consumer goods, furniture upholstery, and soft medical products. Examples of footwear include, but are not limited to, shoe uppers. Examples of clothing articles include, but are not limited to, shirts, shorts, gowns and other medical clothing, dresses, skirts, pants, socks, vests, sweaters, scarves, hats, gloves, mittens, and undergarments. Examples of bags include, but are not limited to, handbags, purses, backpacks, bookbags, satchels and clutches. Examples of automotive interior parts include, but are not limited to, interior panels, interior trim, seat covers, floor mats, dashboard covers and steering wheel covers. Examples of consumer goods include, but are not limited to, laptop/computer housings, soft circuit board coverings, phone cases, soft cleaning products and feminine hygiene products. Examples of furniture upholstery include, but are not limited to, chair and couch coverings, and wall coverings or panels. Examples of soft medical products include, but are not limited to, bandages and various other coverings, slings, and various other stabilization elements, to include soft goods for internal body use.

The present disclosure relates to the creation of a shoe upper in accordance with the present invention; however, one of skill in the art would understand that any of the above articles (or similar) could be created using the teachings herein without departing from the spirit or scope of the present invention. The above listing of articles is intended to be exemplary and non-limiting.

The present invention includes a solid molded fibrous part 12 that is formed from an aqueous slurry that includes a plurality of fibers 16 (hereinafter referred to as “the slurry 20”). The slurry 20 can include natural fibers, semi-synthetic fibers, synthetic fibers or a combination thereof. Natural fibers include wood fibers, plant fibers, and animal fibers. Wood fibers include, but are not limited to, hardwood and/or softwood fibers, bleached and/or unbleached, virgin and/or recycled. Plant-based fibers can include, but are not limited to, cotton, flax, hemp, jute, ramie, bamboo, sisal, abaca, kapok, coir, and general agricultural waste. Animal fibers can include, but are not limited to, wool, silk, cashmere, alpaca, llama, mohair, yak, camel hair, qiviut, vicuna, angora, and horsehair. The semi-synthetic fibers can include, but are not limited to, cellulose-based fibers such as rayon, viscose, modal, Tencel, Lyocell, and acetate. Synthetic fibers can include, but are not limited to, polyester, nylon, olefin, spandex/elastane, acrylic, PVC, aramid, microfiber. Additionally, sustainable synthetic fibers such as polylactic acid (PLA) fibers and polyhydroxyalkanoates (PHA) fibers can be used. One or more fiber types are added and any other ingredient, such as, but not limited to, biobased and/or synthetic molecules/polymers, and additives can be added to the material to be used, either before formation (while in a fluid state), after the material is dried or after the item (or part of the item) is formed. Biobased molecules/polymers can be added as binding agents and/or retention agents in order to enhance the wet and dry strength of the solid fibrous molded part 12. These biobased molecules/polymers include, but are not limited to, chitosan, starches, ionic starches, cellulosic materials such as, but not limited to, carboxymethylcellulose, nanofibrillated cellulose, nanocelulose, natural rubber latex, collagen, gelatine, alginate, polylactic acid, polyglycolic acid, and polyhydroxyalkanoates. Additionally, synthetic molecules/polymers and synthetic molecules/polymers with a certain amount of biobased carbon can be used in the materials, such as, but not limited to, polyurethane emulsions, thermoplastic materials, and resins, such as polyaminoamide-epichlorohydrin (PAE) in order to improve mechanical strength. One suitable slurry is disclosed in U.S. patent application Ser. No. 17/466,792, the disclosure of which is hereby incorporated by reference.

Referring to FIG. 1, the slurry 20 can be created by combining the fibers 16, water 26, and any other ingredients desired into a mixer 28. FIG. 1 shows an exemplary set up where a series of ingredient sources 30 are in communication with the mixer 28 that enable an amount of various ingredients to be provided (e.g., pumped or gravity fed) into the mixer 28, as desired. In the example shown, up to six ingredient sources 30 are provided. In addition, a water source 32 and a source for fibers 16 are also provided for adding desired amounts of fiber 16 into the mixer 28. Once in the mixer 28, the ingredients are mixed, generally until all ingredients are fully mixed and/or dispersed, and the slurry takes on the form of a mixture, foam, or a homogeneous fiber dispersion. An example of the aforementioned slurry may contain, but is not limited to, the following content: water (20-99.99%), fibers (0.0075-60%), other additives (0.0025-20%).

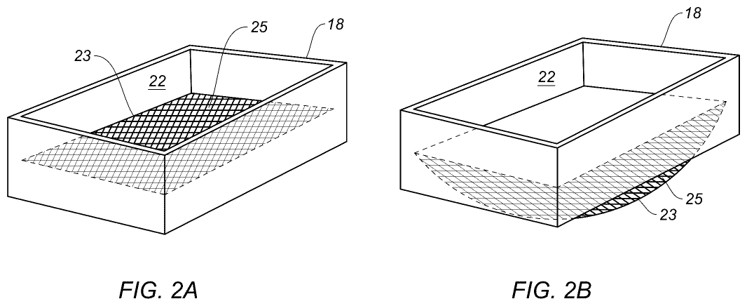

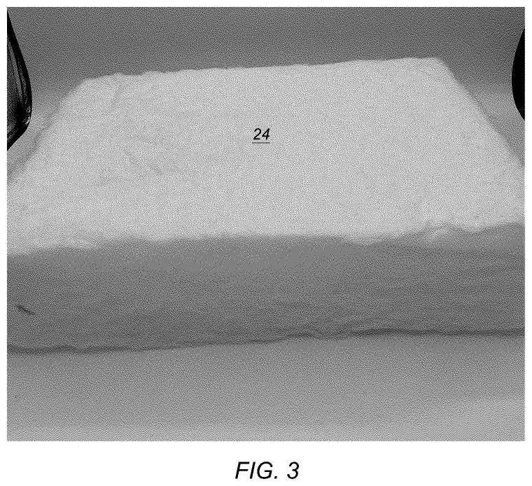

Referring now to FIGS. 2A and 2B, once mixed to the desired consistency, the slurry can be poured, pumped, gravity fed or provided by any other known means into a dehydration chamber 18. The screen can be flat (see FIG. 2A) or include at least one contour (FIG. 2B). The dehydration chamber 18 is composed of walls 22, a screen 23 at the bottom, and a vessel to collect the effluent. The screen has openings 25 generally prevents at least the fibers 16 from the slurry 20 from exiting the dehydration chamber 18 but permits at least some of the water 26 from the slurry to drain, effectively causing dehydration. After the slurry has dehydrated to the desired extent, a substantially flat or contoured fibrous material 24 results and removed from the dehydration chamber 18. The dehydration chamber 18 can be 3D printed or fabricated with PVC, nylon, and wooden materials. An example of a fibrous cuboid material removed from a dehydration chamber is shown in FIG. 3.

After removal from the dehydration chamber 18, the fibrous materials can be substantially flat or contoured material can, optionally, be further dried. In order to achieve the desired intermediate form 14, the substantially flat or contoured fibrous material 24 is then formed in a pressing operation.

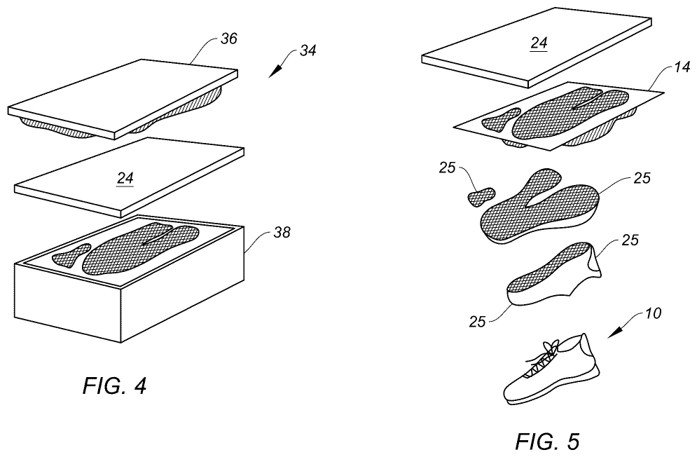

Referring now to FIG. 4, the substantially flat or contoured fibrous material 24 can be placed in a press 34 that includes a first mold portion 36 and a second mold portion 38. For example, one of the mold portions is typically a positive mold and the other is a negative mold. However, the present invention is not so limited, and for example, mold portions can be partially negative and partially positive. When the substantially flat or contoured fibrous material 24 is pressed between the first mold portion and second mold portion, the substantially flat or contoured fibrous material 24 undergoes a shape change. In addition, due to the pressure and, optionally, the addition of heat, fiber to fiber, polymer to polymer, and/or polymer to fiber bonding, as well as chemical cross-linking, occurs creating a material with desired structural stability. The first and second mold portions 26, 28 can be 3D-printed or manufactured from metal. The first and second mold portions 26, 28 may also include additional contours, textures, and/or patterns that leave a desired surface effect on the final object three-dimensional solid fibrous molded part 12.

In an alternative embodiment, although not shown, the substantially flat or contoured fibrous material 24 can be bladder pressed against a single 3D-printed or metal mold portion. In a further embodiment, it may be desirable to achieve the substantially flat or contoured fibrous material 24 by molding the slurry 20 to the intermediate form 14 rather than dehydrating the slurry 20 and then pressing it.

Once the intermediate form 14 has been achieved, it may be necessary to further dry, and/or cut away portions. For example, as shown in FIG. 5, the substantially flat or contoured fibrous material 24 was pressed into a sheet having two different parts formed in a single sheet. Although FIG. 5 shows an intermediate form 14 having two parts, the intermediate form 14 can have but a single final part, or three or more without departing from the scope of the present invention. Preferably, the intermediate part 14 includes a flatter or less contoured version of the final part in a shape that is, e.g., stackable. For example, in FIG. 5, one part is a “butterflied” shoe upper and the second part is a shoe heel. In this shape, the product is far more stackable and potentially less expensive to ship than in its final form as a completed shoe (as is also shown in FIG. 5). The parts are then cut free from the extraneous material. In embodiments where the intermediate part 14 has a plurality of parts therein, or has a single part but excess materials, the part(s) may be trimmed through any known means, including cutting, stamping, or trimming. Finally, the final shape and/or product can be achieved via further processing via gluing, sewing, tying, taping, welding to another object to achieve the desired final shape/product. For example, in the example shown in FIG. 5, the two molded parts cut from the intermediate part 14 (i.e., the shoe upper and the heel of the shoe) are affixed to one another, holes are cut in the material and strung with a shoelace, and a shoe sole is attached. The final product includes a highly contoured item and can include surface effects while made with fewer parts than traditional methods and a reduced number of manufacturing steps.

In operation, and referring to FIG. 1, the components to the slurry 20, including at least water 26, a single type of fiber or a plurality of fiber types 16, and, optionally, additives are provided to a mixer 28. The components are mixed until the slurry 20 is a mixture, foam, or a homogeneous suspension.

Referring to FIGS. 2A and 2B, the slurry 20 is then added to a dehydration chamber 18 where some, most, or all of the water (depending on final product material) from the slurry 20 is drained, effectively dehydrating the substance during the process of converting the slurry 20 to an intermediate form 14.

Referring to FIG. 3, the intermediate form 14 is removed from the dehydration chamber 18 and, optionally, further dried. Then, and now referring to FIG. 4, the intermediate form 14 is placed in a press 34 between a first mold portion 36 and a second mold portion 38. Pressure and/or heat is applied to the intermediate form 14 causing fiber to fiber, polymer to polymer, and/or polymer to fiber bonding, as well as chemical cross-linking, occurs creating a material with desired structural stability. The result is a three-dimensional solid fibrous molded part 12.

Referring to FIG. 5, one or more parts may be trimmed from the three-dimensional solid fibrous molded part 12 and then secondary operations can be undertaken to achieve a final product. The secondary operations may take place at the same location as the other processes, or may take place at a different, more convenient location after the three-dimensional solid fibrous molded part 12 has been shipped.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method for forming a fibrous molded article, comprising:
providing a slurry that contains at least an amount of water and a plurality of fibers;
providing the slurry into a dehydration chamber, the dehydration chamber having a screen capable of permitting water to flow therethrough but to substantially prevent the fibers from the slurry from passing therethrough;
dehydrating the slurry by permitting at least some of the amount of water to flow through the screen until substantially flat or contoured fibrous material is achieved;
removing the fibrous intermediate form from the dehydration chamber;
placing the fibrous intermediate form in a press having a first mold portion and a second mold portion wherein at least one of the first or second mold portions includes a contour;
applying at least one of heat and pressure to the press such that at least fiber to fiber bonding or chemical cross-linking of fibers occurs; and
removing the intermediate part from the press, the intermediate part comprising of three-dimensional solid fibrous materials.

2. The method of claim 1 wherein the slurry is in the form of a mixture, foam, or homogeneous suspension after mixing.

3. The method of claim 1 wherein the slurry includes at least one type of fiber selected from a natural fibers, semi-synthetic fibers, and synthetic fibers.

4. The method of claim 3, wherein the slurry includes at least two types of fibers selected from natural fibers, synthetic fibers, semi-synthetic fibers, and synthetic fibers.

5. The method of claim 1, wherein the slurry includes biobased molecules or polymers.

6. The method of claim 5, wherein the biobased molecules or polymers is one of chitosan, starches, ionic starches, cellulosic materials such as, but not limited to, carboxymethylcellulose, nanofibrillated cellulose, nanocellulose; natural rubber latex, collagen, gelatine, alginate, polylactic acid, polyglycolic acid, and/or polyhydroxyalkanoates.

7. The method of claim 1 wherein at least one of the first mold portion and the second mold portion includes at least one of a contour, a texture, a pattern that is imparted onto the three-dimensional solid fibrous molded part.

8. The method of claim 1 wherein heat and pressure is applied to the press.

9. The method of claim 1 wherein three-dimensional solid fibrous molded part includes one or more final parts and excess materials.

10. The method of claim 9 wherein the excess material is removed from the one or more final parts.
